(19) United States
(12) Patent Application Publication
(10) Pub. No.: US 2014/0165920 A1
(43) Pub. Date: Jun. 19, 2014

(54) No-Drip Bowl

(71) Applicants: Danielle Sarty, Halifax (CA); Philip Levy, Halifax (CA)

(72) Inventors: Danielle Sarty, Halifax (CA); Philip Levy, Halifax (CA)

(21) Appl. No.: 14/105,248

(22) Filed: Dec. 13, 2013

Related U.S. Application Data
(60) Provisional application No. 61/737,149, filed on Dec. 14, 2012.

(51) Int. Cl. A01K 7/00

(52) U.S. Cl. CPC A01K 7/005
USPC 119/72

(57) ABSTRACT

Disclosed is a no-drip water bowl comprised of a bowl and a removably attached lid having a drinking aperture lined with inwardly-facing, soft bristles. The bristles wipe water and drool from the snout of a drinking animal as it withdraws its snout from the drinking aperture. This prevents the animal from dripping liquid onto the floor around the bowl, which at a minimum requires effort to clean up and potentially could lead to injuries from slip-and-fall accidents or the flooring having to be replaced because of water damage.

### CROSS REFERENCE TO RELATED APPLICATION

This application claims the benefit of U.S. Provisional Application No. 61/737,149 filed on Dec. 12, 2012. The above identified patent application is herein incorporated by reference in its entirety to provide continuity of disclosure.

### BACKGROUND OF THE INVENTION

1. Field of the Invention

The present invention relates to animal feeding bowls, and more specifically, to animal water bowls designed to reduce or eliminate the amount of excess spillage of water or drool by the animal while drinking.

Water bowls are an absolutely necessary requirement for owning most pets, including dogs; however animals are rarely careful drinkers and spillage of water or drool in the area around the water bowl can lead to several undesirable consequences. For example, excess liquid on the floor requires effort to clean up. Liquid on the floor can also create a slick surface that can cause either the pet or humans to slip, potentially resulting in injuries. Excess liquid on the floor can also lead to discoloration or damage to flooring, requiring the pet's owner to replace the flooring, which can be expensive. Therefore, devices that reduce or eliminate the amount of water or drool spilled by animals drinking at water bowls is highly desirable.

Current devices in this area try to solve this problem in two main ways. First, they have a lid over the bowl that has a downward incline to a smaller drinking aperture. This approach limits the area from which the animal has to drink and provides a spill guard around said area to attempt to catch any drips or splashes. This approach does not provide any means for actively removing the water from the snouts of the animals though, so the animal is still free to move or shake its head outside the area of the spill guard and thereby get excess liquid on the floor. A second approach provides downturned flanges along the lip of the bowl, creating a curved hollow space along the inward edge of the bowl. This approach seeks to address spills caused by the bowl being either kicked or otherwise jostled by the animal. This does not prevent spills or drips from the animal's snout after the animal has finished drinking.

The present invention seeks to address the problems with these approaches by providing a plurality of inwardly-facing bristles along the edge of the drinking aperture. The animal puts its snout into the drinking aperture to get water and then when it finishes drinking and pulls its snout out, the bristles wipe away any water or drool remaining on the animal's snout. By wiping away this excess liquid, the animal cannot then spill it on the floor around the water bowl. This system of actively removing the liquid is much more effective than passive systems that merely seek to catch what immediately drips off of the animal. The present invention also seeks to address problems with animals kicking or jostling the water bowl, resulting in spills, by having embodiments with a weighted base that is sturdier and harder to move. Additionally, the lip of the lid and the bristles together extend over the surface of the water, helping to prevent water from spilling out from tipping of the bowl.

2. Description of the Prior Art

Devices have been disclosed in the prior art that relate to spill-resistant animal feeding bowls. These include devices that have been patented and published in patent application publications. These devices generally relate to water or food bowls that limit the size of the animal's access point or provide curved edges to limit spillage over the top lip of the bowl. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 5,791,287 to Gruber, which discloses a splash-resistant water bowl comprised of a bowl with a hollow curved lid and a substantially concave floating dish within the body of the bowl. The floating dish has a hole that allows some water to pass through it, creating two bodies of water within the dish. The floating plate acts as a cover preventing the majority of the water from splashing out of the body and the inwardly curved lip of the lid prevents the remaining water above the plate from splashing out. Gruber is primarily designed to prevent water from splashing out of the bowl due to kicking or dropping and is not designed to address water or drool that drips from the snout of the animal when it removes its snout from the drinking aperture. The present invention utilizes soft bristles aligned around the drinking aperture to wipe away water or drool from the animal's snout after it finishes drinking.

Another such device is U.S. Pat. No. 5,881,670 to Pelsor, which discloses a splash-resistant animal container comprised of a bowl with a partition dividing the bowl into an inverted channel and a reservoir, with an aperture that allows water to flow from the reservoir into the inverted channel. The device also has an internal downturned flange along the upper edge of the bowl, preventing liquid from splashing out during lateral jarring of the water bowl. Like Gruber, Pelsor is primarily concerned with preventing spills due to either kicking or jostling of the bowl by an animal. Pelsor seeks to prevent drool from reaching the surrounding area with the inverted channel, which is larger in area than the drinking aperture and thus can catch excess drool. However, Pelsor's passive system for catching drool and excess water only works as long as the animal keeps its head over the water bowl. As soon as the animal moves its head, the excess water and drool is splashed over the surrounding floor. The present invention seeks to improve upon this passive system by actively removing the excess water and drool from the animal's snout before it has the chance to drip on the surrounding area.

U.S. Pat. No. 7,017,518 to Zolnierz discloses a guard device that attaches to a pet feeding bowl. The guard is a bowl-shaped device that has a larger diameter than the bowl, thereby catching drippings from the animal that would otherwise not be caught. Zolnierz, like all of the preceding devices, only acts as a passive system for preventing spillage and it relies upon the animal keeping its face and snout over the bowl long enough for all of the drool and excess water to be caught. If the animal fails to keep its snout in that position long enough, the device completely fails to prevent spillage.

Finally, U.S. Published Patent Application Publication No. 2012/003,1342 discloses a dog food bowl that is intended to prevent an animal from drooling or splashing excess liquid to the surrounding floor. The device is composed of a bowl with a lid sloping generally downward to a drinking aperture. The drinking aperture forms a tunnel that extends downwards into the inner volume of the bowl, but does not extend all the way to the base of the bowl. The bowl only gives the animal access to a limited amount of liquid at a time, thereby preventing or limiting drool formation as the animal drinks. The present invention also only gives the animal access to a limited amount of drinking water at a time, but the present invention has the additional features of the bristles that wipe the water away from the animal's snout. The bristles provide a much more efficient means of ensuring that the animal does not spill excess liquid on the surrounding floor.

The present invention is a new and improved animal drinking bowl. The present invention comprises a bowl and a lid removably attached to said bowl having a central open aperture lined by a plurality of soft bristles extending inwardly. The bristles do not extend all the way to the center of the bowl, but rather terminate a certain distance from the center to create a drinking aperture from which the animal may drink. It prevents the spilling or splashing of drool or excess water because the soft bristles that wipe the animal's snout as it removes its snout from the water bowl, thereby substantially removing the drool and excess water. It substantially diverges in design elements from the prior art and consequently it is clear that there is a need in the art for an improvement to existing animal drinking bowl devices. In this regard the instant invention substantially fulfills these needs.

### SUMMARY OF THE INVENTION

In view of the foregoing disadvantages inherent in the known types of animal water bowls now present in the prior art, the present invention provides a new no-drip animal water bowl wherein the same can be utilized for providing convenience for the user when providing their dog or other animal with water while preventing the animal from spilling the water on the surrounding floor.

It is therefore an object of the present invention to provide a new and improved animal water bowl device that has all of the advantages of the prior art and none of the disadvantages.

It is another object of the present invention to provide a water bowl that removes excess drool and liquid from the animal's snout, preventing said liquid and drool from dripping on the surrounding floor.

Another object of the present invention is to provide a water bowl from which animals of different sizes can drink.

Yet another object of the present invention is to provide a water bowl with an easily detachable lid.

A final object of the present invention is to provide a water bowl that prevents injuries and damage to the floor by preventing liquid from being dripped or splashed by the animal onto the surrounding area.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the no-drip bowl.

FIG. 2 shows a cross-sectional view through the vertical axis of the no-drip bowl, demonstrating the staggered row configuration of the bristles in the preferred embodiment.

FIG. 3 shows a cross-sectional view of an alternate embodiment of the present invention having a weighted base, with a call out showing the lid connection means.

### DETAILED DESCRIPTION OF THE INVENTION

Reference is made herein to the attached drawings. Like reference numerals are used throughout the drawings to depict like or similar elements of the no-drip bowl. For the purposes of presenting a brief and clear description of the present invention, the preferred embodiment will be discussed as used for filling the no-drip bowl with water for feeding a dog. The figures are intended for representative purposes only and should not be considered to be limiting in any respect.

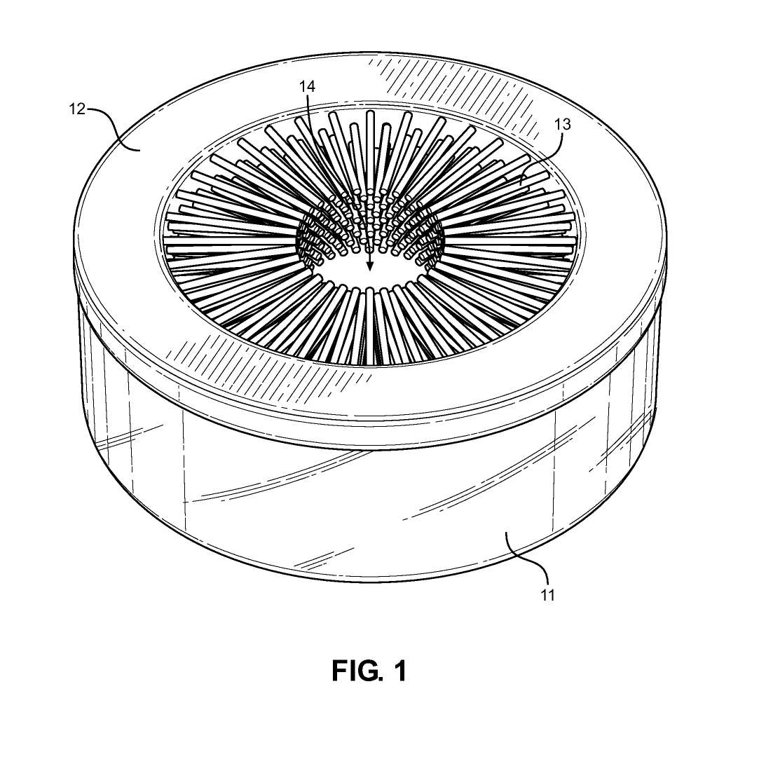

Referring now to FIG. 1, there is shown a perspective view of the no-drip bowl of the present invention. The bowl 11 has a base and a sidewall or sidewalls, depending upon the shape thereof, which form an open reservoir into which any liquid, including water, can be stored for consumption by a pet. In the preferred embodiment, the base of the bowl 11 is weighted in order to help prevent the bowl from being tipped or kicked over by an animal while drinking. The bowl 11 may be weighted via the use of an extra heavy material for the base or by attaching an additional weight to the base. A bowl 11 with a weighted base is harder to tip or kick over because it has a lower center of gravity. The bowl 11 is depicted as roughly cylindrical in shape, but may be of any size and shape.

A lid 12 comprises a central aperture and is removably attached to the bowl 11. A plurality of bristles 13 extend inwardly from the edge of the lid 12 into the central aperture. The inwardly-extending bristles 13 preferably do not extend all the way to the central axis of the bowl, but rather stop a uniform distance from the center in order to create a drinking aperture 14 through which an animal may place its snout and drink water from within the bowl. In the preferred embodiment the inwardly-extending bristles 13 are arranged in a plurality of staggered rows along the edge of the central aperture.

The inwardly-directed bristles 13 are composed of a soft plastic material that has a substantially elastic character. The inwardly-directed bristles 13 are preferably stiff enough such that they are substantially straight when no external forces are applied to them, and yet soft or flexible enough to allow the drinking animal to place its snout within the drinking aperture 14 and then remove its snout without causing any pain or discomfort to the animal. The bristles 13 need only be rigid enough to be straight when there are no forces applied. The inwardly-extending bristles 13 are designed to wipe water or drool off of the snout of the drinking animal as the animal removes its snout from the drinking aperture. This prevents the animal from getting excess water or drool on the surrounding floor, thereby avoiding potential injuries from slipping on the liquid and damage to the floor. The bristles 13 may be composed of any material that has the requisite mechanical properties, as discussed above.

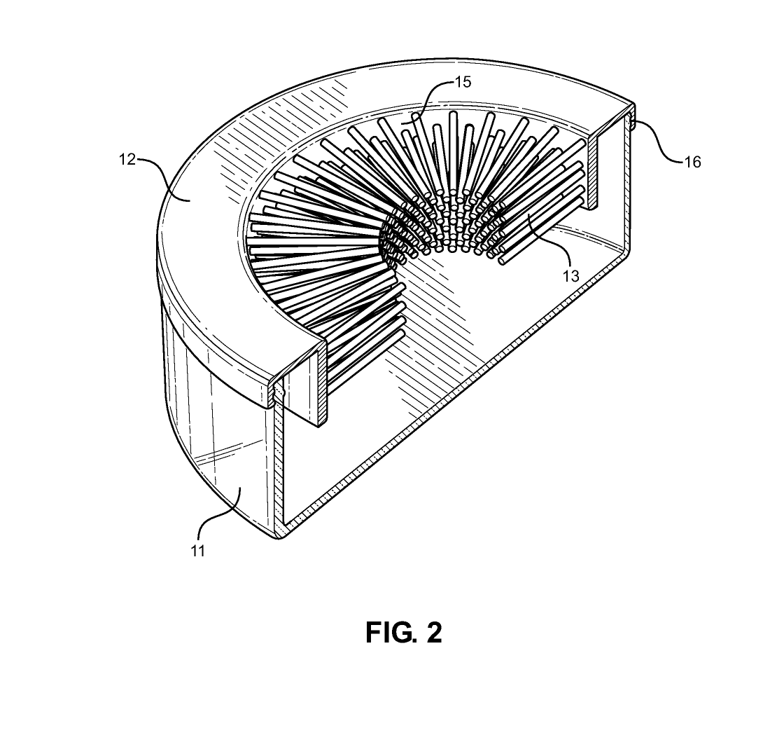

Referring now to FIG. 2, there is shown a cross-sectional view of the present invention. This view shows the preferred embodiment where the inwardly-extending bristles 13 are arranged in a plurality of rows and said rows are in a staggered configuration. This configuration maximizes the amount of excess water and drool that is removed from the drinking animal's snout because it ensures that every portion of the animal's snout that was within the drinking aperture 14 is wiped by at least one bristle 13. This view also shows the hollow interior of the bowl that houses the drinking water. The bowl may be filled either by taking off the removably attached lid 12 or by pouring the water directly into the drinking aperture 14.

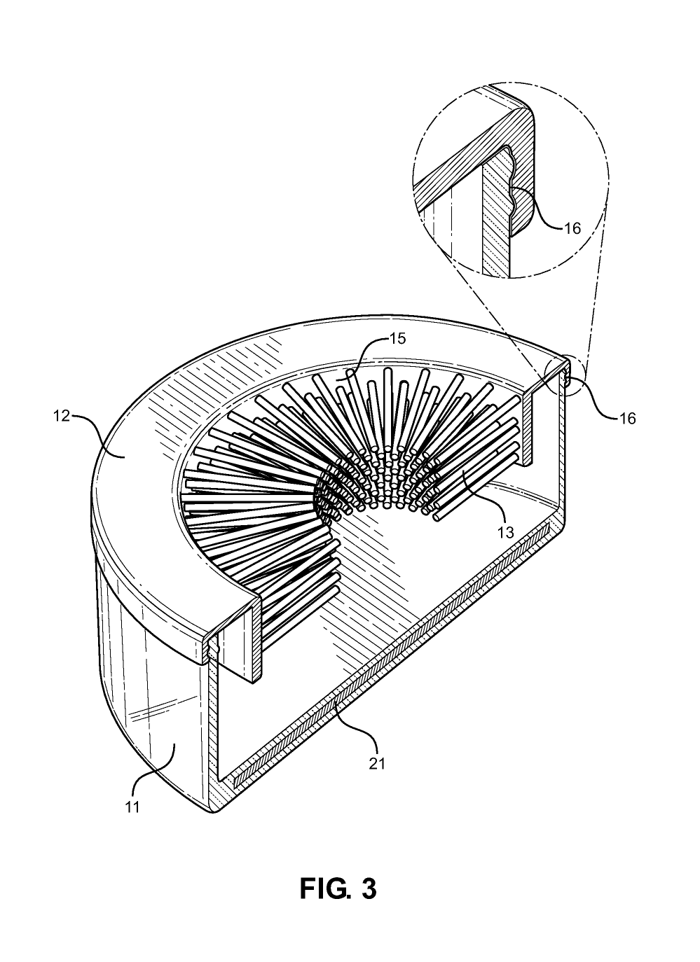

Referring now to FIG. 3, there is shown a cross-sectional view of an alternate embodiment of the present invention having a weighted base, with a call out showing the lid connection means. The present invention preferably has a weighted base 21 affixed to the bottom of the bowl 11. The weighted base 21 may comprise a separate piece of material affixed to the bottom of the bowl 11 or may comprise an integral material contained within the base of the bowl 11. The weighted base 21 is provided in order to lower the center of gravity of the present invention, thereby rendering the device more difficult to flip or otherwise knock over. This, along with the bristles 13, further prevents a careless animal from spilling liquid contained within the bowl 11. The weighted base 21 may comprise lead or any other type of similar heavy material.

The lid 12 comprises an edge portion extending horizontally from the periphery of the bowl 11, a lip connection means 16 running along the outer periphery of the lid 12, and an aperture support surface 15 extending vertically downward from the internal rim of the edge portion. The inwardly-directed bristles 13 are attached at one end to the aperture support surface 15 and extend therefrom into the central portion of the bowl. The lip connection means 16 is provided in order to removably secure the lid 12 to the bowl 11. The lip connection means 16, as depicted, comprises a notched, flexible flange portion of the lid 12 that engages with a complimentary surface on the exterior edge of the bowl 11. However, no claim is made as to the exact structure of the lip connection means 16.

Overall, the present invention provides a drinking bowl with a unique removably attached lid that prevents spills on the floor surrounding the drinking bowl while, and after, the animal drinks. Spills of excess liquid, including water or drool, can be potentially dangerous to both the animal and humans because liquid can create a slick surface on the floor that can lead to slip-and-fill injuries. Excess liquid on the floor can also warp, discolor, or otherwise damage the floor, which can be very expensive to replace. Finally, excess liquid is simply annoying to clean up. The present invention seeks to solve these problems by preventing the excess water and drool from leaving the drinking aperture of the bowl. Other inventions in the field generally seek to prevent spillage by providing a guard region that has a larger area than the drinking aperture and is intended to catch excess liquid dripping from the animal while it drinks. However, these guard regions are rendered ineffective or at least less effective if the animal moves its head away from the bowl before all the excess liquid has finished dripping off the animal. The present invention solves this issue with the soft bristles that wipe the water off of the animal's snout before it has a chance to drip on the surrounding floor.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A no-spill bowl for animals that prevents water spillage during drinking activities, comprising:
a bowl having an upper edge and an interior volume;
a lid removably attached to said bowl along said upper edge;
said lid having an aperture, said aperture lined with a plurality of inwardly-directed bristles;
whereby said bristles are adapted to wipe away liquid from the snout of a drinking animal as the animal withdraws its snout from the bowl.

2. The no-spill bowl of claim 1, wherein said inwardly-directed bristles terminate over said bowl interior volume and form an open aperture adapted to provide access therethrough to said bowl interior volume.

3. The no-spill bowl of claim 1, wherein said inwardly-directed bristles are aligned in a plurality of staggered rows.

4. The no-spill bowl of claim 1, wherein said bowl further comprises a weighted base.
